(19) United States
(12) Patent Application Publication
(10) Pub. No.: US 2006/0170824 A1
(43) Pub. Date: Aug. 3, 2006

(54) User interface feature for modifying a display area

(76) Inventors: Carolynn Rae Johnson, Indianapolis, IN (US); Valerie Sacrez Liebhold, Ashland, MA (US); Paul Wallace Lyons, New Egypt, NJ (US)

Correspondence Address: THOMSON LICENSING INC., PATENT OPERATIONS, PO BOX 5312, PRINCETON, NJ, 08543-5312, US

(21) Appl. No.: 11/047,181

(22) Filed: Jan. 31, 2005

(51) Int. Cl. H04N 5/445; H04N 5/50

(52) U.S. Cl. 348/569; 348/564

(57) ABSTRACT

A method and apparatus are disclosed for modifying the display area of a display device. The invention recognizes whether a region of said display area is occupied by an object, and adjusts the rendering of an on screen display object in an alternative region or removes said occupied region when the display area is rendered on a display device.

### FIELD OF THE INVENTION

The invention concerns the field of rendering video, specifically the display of video on a display device.

### BACKGROUND OF THE INVENTION

When a user watches video on a display device, a menu or other type of banner may appear in the display area of the device if the user performs an operation such as a channel or channel change. Typically, the generated menu is overlaid over the video picture of the program that the user is watching, as shown in FIG. 1. A problem however may result if the user utilizes a set top box or other video source with the display device.

It is possible that the other video source (such as a set top box) has its own menu or other type of object that is also shown on the display device as shown in FIG. 2. When a user operates the set top box with the display device, the video overlay of both the set top box and the display device may interfere with each other as to produce the unsatisfactory result shown in FIG. 3.

### SUMMARY OF THE INVENTION

A method and apparatus are disclosed for modifying the display area of a display device. In one illustrative embodiment of the present invention, the display device moves an object rendered with an on screen display from a first area to a second area when an object collision takes place in the first area.

A method and apparatus are disclosed for modifying the display area of a display device. In another illustrative embodiment of the present invention, the display device detects an area of the display screen that is subject to a text crawl. In response to this detection, the display device scales the video of said display area to remove the area subject to the text crawl.

### BRIEF DESCRIPTION OF THE DRAWINGS

FIG. 1 shows an exemplary embodiment of a display area of a display device rendering a menu function from the display device;

FIG. 2 shows an exemplary embodiment of a display area of a display device rendering a menu function from a set top box;

FIG. 3 shows an exemplary embodiment of a display area of a display device rendering a menu function from the display device and a menu function from a set top box;

FIG. 4 shows an exemplary embodiment of a video decoder system capable of decoding received video programming;

FIG. 5 shows an exemplary embodiment of display device and set top box system capable of decoding received video programming;

FIG. 6 shows an exemplary embodiment of a user operable menu for controlling the location of an object generated by an on screen display;

FIG. 7 shows an exemplary embodiment of text being rendered in a location at the top of a display area;

FIG. 8 shows an exemplary embodiment of two OSD objects in a display area;

FIG. 9 shows an exemplary embodiment of the present invention that operates in view of a text crawl;

FIG. 10 shows an exemplary embodiment of the present invention operating with a sample text crawl;

FIG. 11 shows an exemplary embodiment of the present invention where a display area is divided into macroblocks;

FIG. 12 shows an exemplary embodiment of the present invention where resultant horizontal motion vector for each row of macroblocks is computed by using vector addition; and

FIG. 13 shows an exemplary block diagram for a method for a region bounded by a text crawl using macroblocks and motion detection.

### DETAILED DESCRIPTION OF THE EMBODIMENTS

The present invention is directed towards the modification of a display area of a display device in view of objects (such as an on screen display generated (OSD) menu, text, a channel banner, closed captioning data, a user selectable option, and a text crawl) that may interfere with the display of the video programming. It is understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. Such an application program may be capable of running on an operating system as Windows CE™, Unix based operating system, and the like where the application program is able to manipulate video information from a video signal.

The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. The application program primarily providing video data controls to recognize the attributes of a video signal and for rendering video information provided from a video signal.

The application program may also control the operation of the OSD embodiments described in this application, the application program being run a computer processor as a Pentium™ III, as an example of a type of processor. The application program also may operate with a communications program (for controlling a communications interface) and a video rendering program (for controlling a display processor). Alternatively, all of these control functions may be integrated into the processor for the operation of the embodiments described for this invention.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

The operation of the invention with the OSD displaying menu or text information works with a display processor that displays video signals at different display formats. Video signals that are processed by the display processor are received terrestrially, by cable, DSL, satellite, the Internet, or any other means capable of transmitting a video signal. Preferably, video signals comport to a video standard as DVB, ATSC, MPEG, NTSC, or another known video signal standard.

Similarly, the display OSD operates with a processor coupled to a communications interface as a cable modem, DSL modem, phone modem, satellite interface, or other type of communications interface capable of handling a bi-directional communications. Preferably, the processor is capable of receiving data communicated via a communications interface, such communicated data representing web page data that is encoded with a formatting language as HTML, or other type of formatting commands. Additionally, the processor is capable of decoding data transmitted as an MPEG based transmission, graphics data, audio data, or textual data that are able to be rendered either using a display processor, OSD, or audio processing unit as a SoundBlaster™ card. Such communicated data is decoded and rendered via the processor. In the case of HTML data, a format parser (as a web browser) is used with the graphics processor to display HTML data representing a web page, although other types of formatted data may be rendered as well.

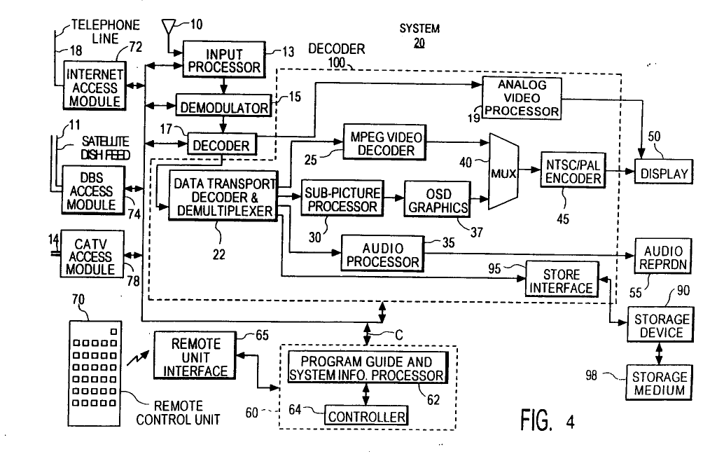

FIG. 4 is an exemplary embodiment of a video decoder system capable of decoding received video programming. The exemplary decoder system is a system that is found in a television or a set top box. Decoder system 20 receives program data and program guide information from satellite, cable and terrestrial sources including via telephone line from Internet sources, for example. In the decoder system of FIG. 4 (system 20), a terrestrial broadcast carrier modulated with signals carrying audio, video and associated data representing broadcast program content is received by antenna 10 and processed by unit 13. Demodulator 15 demodulates the resultant digital output signal. The demodulated output from unit 15 is trellis decoded, mapped into byte length data segments, deinterleaved and Reed-Solomon error corrected by decoder 17. The corrected output data from unit 17 is in the form of an MPEG compatible transport datastream containing program representative multiplexed audio, video and data components. The transport stream from unit 17 is demultiplexed into audio, video and data components by unit 22 that are further processed by the other elements of decoder system 100. These other elements include video decoder 25, audio processor 35, sub-picture processor 30, on-screen graphics display generator (OSD) 37, multiplexer 40, NTSC encoder 45 and storage interface 95. In one mode, decoder 100 provides MPEG decoded data for display and audio reproduction on units 50 and 55 respectively. In another mode, the transport stream from unit 17 is processed by decoder 100 to provide an MPEG compatible datastream for storage on storage medium 98 via storage device 90. In an analog video signal processing mode, unit 19 processes a received video signal from unit 17 to provide an NTSC compatible signal for display and audio reproduction on units 50 and 55 respectively.

Video decoder 25 is conditioned to scale the attributes of a decoded video signal. For example, video decoder 25 zooms in to a specific area of a decoded video signal or video decoder 25 reduces the size of a decoded video signal relative to the display area such a signal will be rendered on. Other scaling functions are available, depending upon the needs of illustrative embodiments of the present invention.

In other input data modes, units 72, 74 and 78 provide interfaces for Internet streamed video and audio data from telephone line 18, satellite data from feed line 11 and cable video from cable line 14 respectively. The processed data from units 72, 74 and 78 is appropriately decoded by unit 17 and is provided to decoder 100 for further processing in similar fashion to that described in connection with the terrestrial broadcast input via antenna 10.

A user selects for viewing either a TV channel or an on-screen menu, such as a program guide, by using a remote control unit 70. Processor 60 uses the selection information provided from remote control unit 70 via interface 65 to appropriately configure the elements of FIG. 4 to receive a desired program channel for viewing. Processor 60 comprises processor 62 and controller 64. Unit 62 processes (i.e. parses, collates and assembles) program specific information including program guide and system information and controller 64 performs the remaining control functions required in operating decoder 100. Although the functions of unit 60 may be implemented as separate elements 62 and 64 as depicted in FIG. 4, they may alternatively be implemented within a single processor. For example, the functions of units 62 and 64 may be incorporated within the programmed instructions of a microprocessor. Processor 60 configures processor 13, demodulator 15, decoder 17 and decoder system 100 to demodulate and decode the input signal format and coding type. Units 13, 15, 17 and sub-units within decoder 100 are individually configured for the input signal type by processor 60 setting control register values within these elements using a bi-directional data and control signal bus C.

The transport stream provided to decoder 100 comprises data packets containing program channel data and program specific information. Unit 22 directs the program specific information packets to processor 60 that parses, collates and assembles this information into hierarchically arranged tables. Individual data packets comprising the User selected program channel are identified and assembled using the assembled program specific information. The program specific information contains conditional access, network information and identification and linking data enabling the system of FIG. 4 to tune to a desired channel and assemble data packets to form complete programs. The program specific information also contains ancillary program guide information (e.g. an Electronic Program Guide—EPG) and descriptive text related to the broadcast programs as well as data supporting the identification and assembly of this ancillary information.

Processor 60 assembles received program specific information packets into multiple hierarchically arranged and inter-linked tables. The hierarchical table arrangement includes a Master Guide Table (MGT), a Channel Information Table (CIT) as well as Event Information Tables (EITs) and optional tables such as Extended Text Tables (ETTs). The hierarchical table arrangement also incorporates new service information (NSI) according to the invention. The resulting program specific information data structure formed by processor 60 via unit 22 is stored within internal memory of unit 60.

FIG. 5 is an exemplary embodiment of display device and set top box system 500 capable of decoding received video programming. Antenna 510 is used to receive video signals that are transmitted terrestrially. Some formats of such video signals include NTSC, ATSC, PAL, DVB-T, and the like. Display device 530 is a device such as a television set, display monitor, and the like, that is capable of demodulating and decoding a video signal that is received via antenna 510 using a decoder, as found in FIG. 4. Similarly, set top box 520, that is coupled to display device 530, is used for receiving, demodulating, and decoding video signals from sources such as a satellite dish, cable network, data network, and the like. Set top box 520 also contains a decoder as represented in FIG. 4. It is noted that display device 530 is capable of rendering a video signal received from set top box 520 or decoded in display device 530 itself.

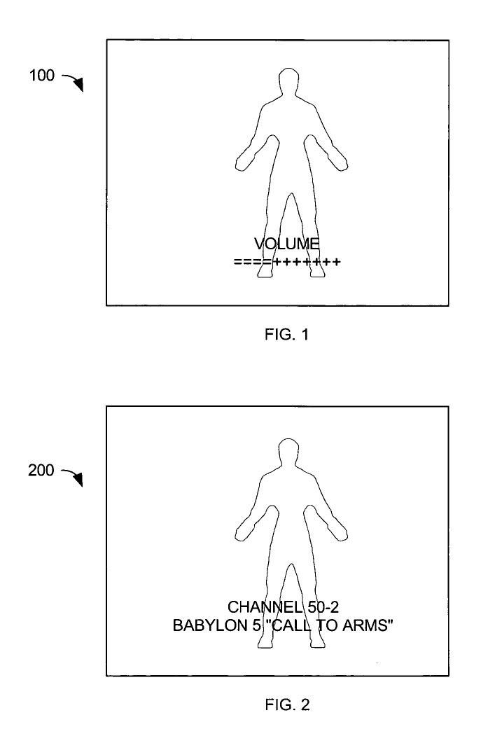

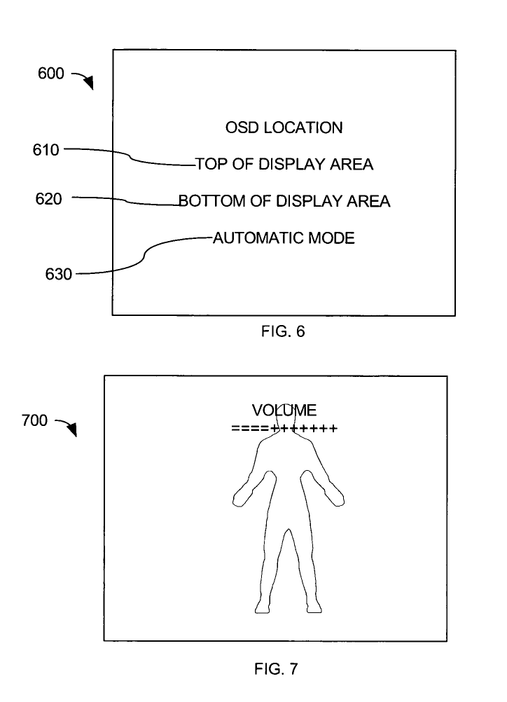

FIG. 6 is an embodiment of a user operable menu 600 for controlling the location of an object generated by an on screen display, such objects being text, a channel banner, closed captioning data, a user selectable option, a menu, and the like. The options present in menu 600 are initiated by operating a control device such as remote control 70 from FIG. 4. Menu 600 controls where an OSD generated object is placed within the display area of a display device. Option 610 would render text in a location at the top of display area 700, as shown in FIG. 7. Conversely, option 620 would render text in a location at the bottom of the display area 100, as shown in FIG. 1.

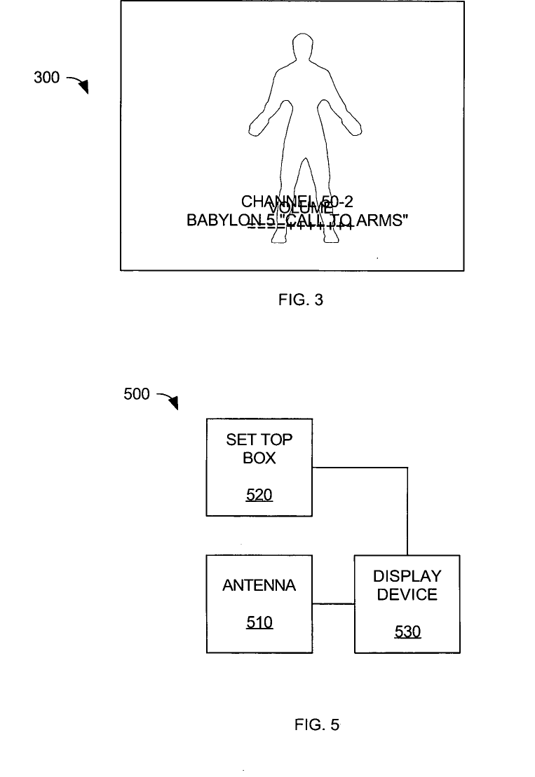

If a user selects option 630, the display device is configured to have OSD generated object be placed in a location that would not interfere with the placement of OSD text from a video source, such as a set top box. As shown previously in FIG. 3, it is possible that the OSD generated object from a set top box (such as channel information) interferes with the OSD generated object that is generated from a display device (such as volume control). One way of accomplishing this function is to configure video decoder 25 with software program that is capable of recognizing text characters such as Optical Character Recognition (OCR) software.

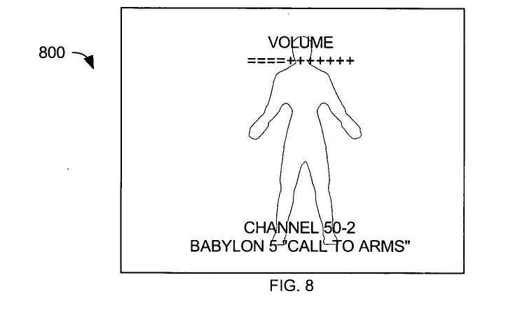

Upon the recognition by video decoder 25 that an OSD generated object is already located in a display area, video decoder 25 moves the OSD object that it creates to a second location in display area. As shown in FIG. 8, the OSD object generated by a set top box is located at the bottom of the display area 800 and the OSD object generated from the display device is located at the top of display area 800.

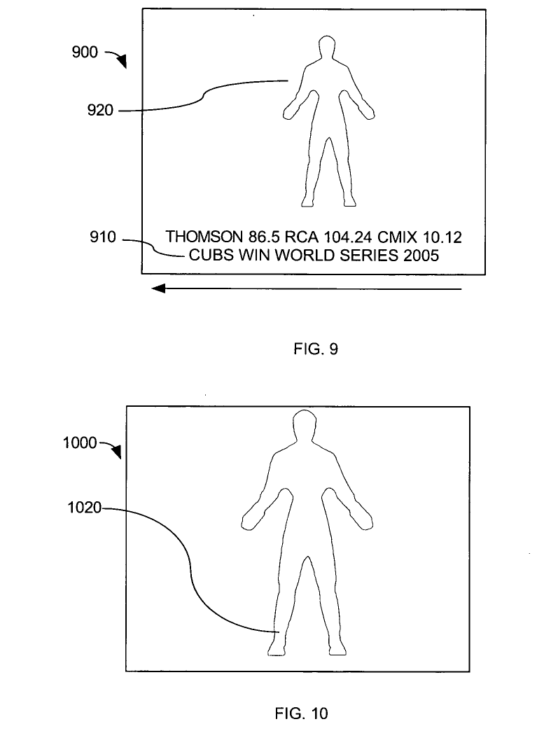

FIG. 9 presents an embodiment of the present invention that operates in view of a text crawl. Typically, video programming that comes from sources such as news stations use a feature called text crawl where text 910 (representative of stock quotes, news from news wires, school closings, and the like) is scrolled across the bottom of a video picture. The scrolling of text 910 usually moves in a right to left direction, although for other languages it is possible text 910 moves in a left to right direction, representing a text crawl region. Video 920 represents the video from a television programming occupying a non-text crawl region. The combined areas of text 910 and video 920 are usually generated at the point of a broadcaster and are transmitted together as part of a video signal without the use of an OSD at the point of reception.

A display device can be configured to recognize the presence of a text crawling across a display area and eliminate such text. By analyzing the success video frames of decoded video, a display device determines a bounded region of a display area that is occupied by the video crawl text inserted by a broadcaster.

The inventors recognize that video crawl text region is typically located at the lower extremity of a display area. This region lends itself to the removal of the text crawl from the display area by excising the horizontal lines occupied by the text crawl from the display area. Preferably, this operation is accomplished by scaling the video display area by use of video decoder 25 (from FIG. 4) by resizing or interpolation techniques. The result of such an operation is shown in FIG. 10, with display area 1000 and video 1020 where alternative video from a region not occupied by said text crawl is used to occupy the region associated with said text crawl region.

Specifically, text crawl can be detecting by using motion detection techniques and/or OCR devices. Optical characters or block motions vectors within a crawl area exhibit a horizontal motion that is restricted in the magnitude of the motion of the text crawl where such text moves at a relative horizontal velocity across a display area. Once such conditions are detect, the bounded area described by this activity is defined and the horizontal lines occupied by the text crawl are identified. This area of text crawl is then excised from a rendered display area.

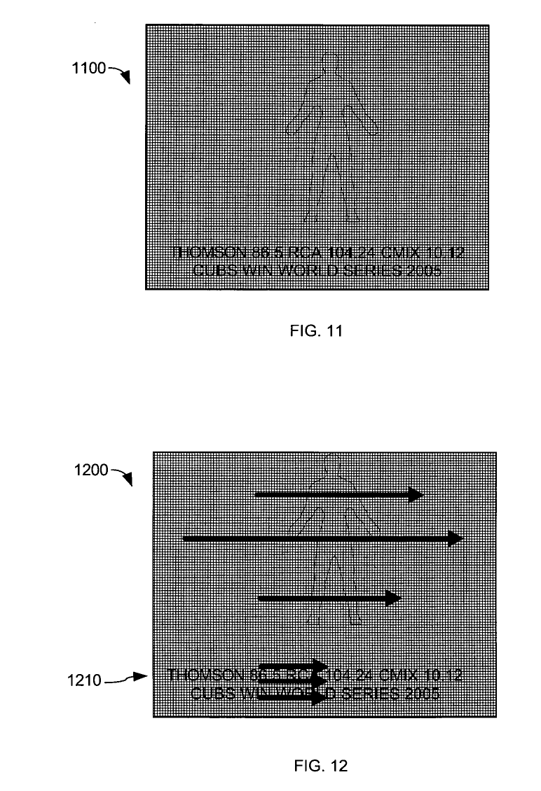

The operation of using motion detection to detect a text crawl begins with the process shown in FIG. 11, where a display area 1100 is divided into macroblocks. This division is not rendered on the display device for display, but rather internally in video decoder 25 (of FIG. 4). This division of the display area in macroblocks takes into account a process called interframe encoding which determines changes in a new frame relative to a preceding frame. If there is no change between such frames, only small amounts of data are needed to present a current frame. The frame-to-frame changes in interframe encoding present movement in a video picture relative to the preceding frame, and such a changes are represented as motion vectors. Using motion vectors along with a preceding video frame is known as motion compensation or motion prediction. Hence the present frame is “predicted” by using motion vectors that point to the data that describes the preceding. Hence, between frames, the motion vectors corresponding to the text crawl should be constant and pointing in the same direction.

In order to determine the motion vectors corresponding to a text crawl, video decoder 25 performs a motion compensation operation to detect the rectilinear motion of a present frame relative to a preceding frame. Changes in the vertical and horizontal directions of the blocks that constitute a video frame are detected and used to predict the corresponding blocks of the present frame. The horizontal motion of a text crawl is detected by analysis and comparison of horizontal motion vectors in a particular region of the video area relative to the horizontal motion vectors throughout the whole video area. A resultant horizontal motion vector for each row of blocks is computed by using vector addition, as shown in display area 1200 of FIG. 12. Hence, the region of the display area containing the text crawl has resultant horizontal motion vectors with a magnitude and direction constantly different from those generated in other parts of the display area. Therefore, the region 1210 bounded by the identified motion vectors resultants (which are identical or close to being identical) define the region of the display area containing the video crawl.

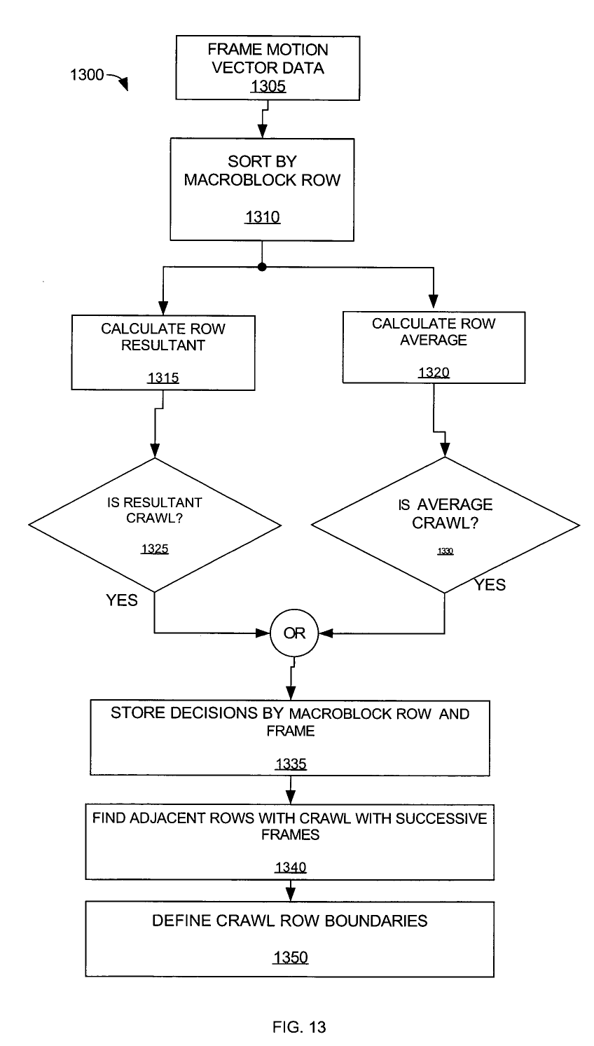

FIG. 13 presents a block diagram for determining a region bounded by a text crawl using macroblocks and motion detection. In step 1305, the method begins with a frame motion vector data being calculated by a particular video frame from a decoded video signal. Preferably, this operation is shown as taking place in FIG. 11 by video decoder 25. In the next step 1310, video decoder 25 sorts the resulting macroblocks by row.

The process continues with a bifurcated process where in step 1315, each row of macroblocks for a particular frame is compared against a second row of macroblocks from a previous frame. This operation helps determine a series of vectors that correspond to horizontal motion of such macroblock rows. Then in step 1325, it is determined if the resultant of such vectors corresponds to a text crawl if a number of resultant vectors have the close to the same magnitude and point to the same direction, as defined above.

Step 1320 proceeds in a similar fashion as step 1315, but instead of calculating resultant motion vectors between at least two frames for rows of macroblocks, motion vectors corresponding to rows of macroblocks representing an average, are calculated. Then in step 1330, it is determined if the resultant of such average vectors correspond to a text crawl if the resulting vectors have the close to the same magnitude and point to the same direction.

If either steps 1325 and/or 1330 result in a determination that macroblocks corresponding to a certain row or rows represent a text crawl, step 1335 has information being stored that corresponds to the macroblock rows and frames that have been identified as being associated with a text crawl. In step 1340, video decoder 25 determines which rows of macroblocks have resultant vectors that have been identified as being associated with a text crawl. In step 1350, video decoder 25 defines the crawl boundaries and excises such a region from the display area by the removal of the rows corresponding to such a region or a video scaling function.

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard drives, high density disk, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

1. A method for modifying a display area capable of being displayed on a display device comprising the steps of:
rendering a video signal comprising video data as a display area;
generating an on screen display generated object in a first area; and
generating said on screen display object in a second area when said first area is occupied by a second on screen display generated object.

2. The method of claim 1, wherein said second on screen display object is inserted in said video data by a source external to said display device.

3. The method of claim 1, wherein said second on screen display object is recognized by use of an optical character recognition algorithm.

4. The method of claim 1, wherein said first area is at a bottom of said display area and said second area is at the top of said display area.

5. The method of claim 1, wherein said on screen display object is at least one of: text, a channel banner, closed captioning data, a user selectable option, and a menu.

6. The method of claim 1, wherein said step of generating an on screen display object in said second area is toggled via a menu option.

7. A method for detecting a text crawl region in a display area to be rendered comprising the steps of:
detecting said text crawl region in said display area to rendered;
rendering said display area by eliminating said text crawl region from said display area.

8. The method of claim 7, wherein said rendering of said display area step involves an operation of scaling video such that said display area is rendered with alternative video occupying said text crawl region from a region not occupied by said text crawl.

9. The method of claim 7, further comprises the steps of:
dividing said display area into macroblocks; and
performing a motion estimation operation for determining motion vectors corresponding to horizontal rows of said macroblocks.

10. The method of claim 9, further comprising the step of:
matching motion vectors with approximately the same magnitude and direction; and
determining that if said motion vectors are adjacent, a region occupied by macroblocks corresponding to said motion vectors is said text crawl region.

11. An apparatus for rendering a display area for a display device comprising:
a video input;
a video processor that determines whether a video information received from said video input contains a region occupied by an object;
said video processor renders said video information as a display area without said region occupied by said object by scaling said video information to fill said region occupied by said object.

12. The apparatus of claim 11, wherein said object is an on screen display object.

13. The apparatus of claim 11, wherein said object is text that crawls across a display screen.

14. The method of claim 13, wherein said video processor determines said region occupied by said object by performing a motion estimation operation where motion vectors are associated with horizontal rows of macroblocks generated from said display area.
